(19) United States
(12) Patent Application Publication
(10) Pub. No.: US 2016/0286241 A1
(43) Pub. Date: Sep. 29, 2016

(54) APPARATUS, A METHOD AND A COMPUTER PROGRAM FOR VIDEO CODING AND DECODING

(71) Applicant: Nokia Technologies Oy, Espoo (FI)

(72) Inventors: Justin RIDGE, Sachse, TX (US); Miska Matias HANNUKSELA, Tampere (FI); Jani LAINEMA, Tampere (FI)

(21) Appl. No.: 14/666,670

(22) Filed: Mar. 24, 2015

(51) Int. Cl. H04N 19/98; H04N 19/186

(52) U.S. Cl. CPC H04N 19/98; H04N 19/186

(57) ABSTRACT

A method comprising: obtaining a video bitstream comprising a high dynamic range (HDR) video representation; obtaining one or more tone mapping operators and an indication of at least one tone mapping operator to be applied; and modifying the HDR video representation into a low dynamic range (LDR) video representation using said at least one tone mapping operator determined by said indication.

### TECHNICAL FIELD

The present invention relates to an apparatus, a method and a computer program for video coding and decoding.

### BACKGROUND

Typical video codecs have at least one operating mode where the digital representation of video has a bit depth of 8, or ‘8-bit video’. Newer video codecs may have additional operating modes for greater bit depths, including 10-bit video.

The human eye can typically perceive a range of brightness equivalent to approximately five orders of magnitude. However, media such as the printed page can only span approximately two orders of magnitude. Traditional video display devices, such as cathode ray tubes (CRT) and liquid crystal displays (LCD) have similar limitations. This range of brightness is called the ‘dynamic range’.

To maximize compression efficiency, traditional video codecs have been designed to compress video with the typical video display devices in mind, that is, those with a low dynamic range (LDR), or covering approximately two orders of magnitude. However, it may be desirable to display video in a manner that exploits the capabilities of the human eye in order to achieve a more visually pleasing experience for the viewer. Thus it is desirable to display video with a high dynamic range (HDR), or up to five orders of magnitude.

It may be possible that a video content producer wishes to make content available for display on conventional (LDR) displays, but also wishes to exploit the enhanced capabilities of newer HDR displays. However, typically at least 12-bit video is required for HDR representation, and no single compressed representation of the video exists that can be used for both LDR and HDR displays operating to the limits of their capabilities.

### SUMMARY

Now in order to at least alleviate the above problems, a method for modifying an HDR video representation into an LDR representation is presented herein.

A method according to a first aspect comprises

obtaining a video bitstream comprising a high dynamic range (HDR) video representation;

obtaining one or more tone mapping operators and an indication of at least one tone mapping operator to be applied; and

modifying the HDR video representation into a low dynamic range (LDR) video representation using said at least one tone mapping operator determined by said indication.

According to an embodiment, said indication comprises a specification of a tone mapping operator through the presence of one or more syntax elements, the syntax elements or their value(s) indicating which one of said tone mapping operators is used in the step of modifying the HDR video representation.

According to an embodiment, said syntax element is modified by means of an algorithm, the result of said algorithm indicating which one of said tone mapping operators is applied to said high dynamic range video representation.

According to an embodiment, the one or more tone mapping operators comprise a pre-defined list that is known to the decoder.

According to an embodiment, said indication comprises a specification of a tone mapping operator including presence of a look-up table to be used for substituting lower dynamic range and/or lower bit depth values for higher dynamic range and/or higher bit depth values present in the video bitstream.

According to an embodiment, said look-up table is stored in compressed form using either variable-length coding or arithmetic coding.

According to an embodiment, said look-up table is stored partially by means of pivot points representing a piecewise linear function, such that said look-up table is determined by decoding of the pivot points and interpolating the remaining values.

According to an embodiment, said look-up table comprises only a luminance component for the HDR representation and the LDR representation.

According to an embodiment, said look-up table comprises more than one color component for the HDR representation and the LDR representation.

According to an embodiment, said indication comprises a specification of a tone mapping operator including presence of parametric values that are applied to a mathematical function to derive a tone mapping function, or parametric values that determine local adaptation of a tone mapping operator.

According to an embodiment, at least one tone mapping operator is associated with a specification of target display characteristics.

According to an embodiment, said indication comprises at least two tone mapping operators, and the step of modifying the HDR video representation comprises sequential application of said at least two tone mapping operators.

According to an embodiment, said indication comprises at least two tone mapping operators, and the step of modifying the HDR video representation comprises application of all said at least two tone mapping operators and the combination of said application in a weighted sum.

According to an embodiment, said weighted sum is computed using the maximum luminance of a target display and the maximum luminance provided for in said at least two tone mapping operators.

According to an embodiment, said indication of at least one tone mapping operator to be applied comprises a map indicating at least one tone mapping operator to be applied to each particular pixel in a frame or a subset of a frame of video.

According to an embodiment, said indication of at least one tone mapping operator to be applied comprises a region indicating at least one tone mapping operator to be applied to each particular pixel within that region.

According to an embodiment, the step of obtaining one or more tone mapping operators and an indication of at least one tone mapping operator to be applied is repeated temporally according to an algorithm such that said tone mapping operators so obtained replace any tone mapping operators previously in effect.

According to an embodiment, the step of modifying the HDR video representation into a low dynamic range (LDR) video representation using said at least one tone mapping operator determined by said indication additionally comprises a pre-processing operation.

According to an embodiment, said pre-processing operation comprises an inverse tone mapping operation, said inverse tone mapping operation being derived from said indication.

According to an embodiment, the step of obtaining a video bitstream comprising a high dynamic range (HDR) video representation additionally comprises obtaining an indication of HDR metadata.

According to an embodiment, said HDR metadata comprises information about tone mapping operators that have already been applied to said HDR video representation.

According to an embodiment, said HDR metadata comprises an indication of whether pre-processing of the HDR video representation is required prior to the step of modifying the HDR video representation into a LDR video representation.

A second aspect relates to an apparatus comprising

at least one processor and at least one memory, said at least one memory stored with code thereon, which when executed by said at least one processor, causes the apparatus to perform at least

obtaining a video bitstream comprising a high dynamic range (HDR) video representation;

obtaining one or more tone mapping operators and an indication of at least one tone mapping operator to be applied; and

modifying the HDR video representation into a low dynamic range (LDR) video representation using said at least one tone mapping operator determined by said indication.

According to a third aspect, there is provided a method comprising:

providing a high dynamic range (HDR) video representation or information relating to the HDR video representation; and

providing a bitstream comprising one or more tone mapping operators and an indication of at least one tone mapping operator to be applied to said HDR video representation.

According to an embodiment, said indication comprises a specification of a tone mapping operator including presence of one or more syntax elements, the syntax elements or their value(s) indicating a mathematical operation to be applied to one or more of said tone mapping operators.

According to an embodiment, said indication comprises a specification of a tone mapping operator including presence of a look-up table to be used for substituting lower dynamic range and/or lower bit depth values for higher dynamic range and/or higher bit depth values present in the video bitstream.

According to an embodiment, said look-up table comprises only a luminance component for the HDR representation and the LDR representation.

According to an embodiment, said look-up table comprises more than one color component for the HDR representation and the LDR representation.

According to an embodiment, said indication comprises a specification of a tone mapping operator including presence of parametric values that are applied to a mathematical function to derive a tone mapping function, or parametric values that determine local adaptation of a tone mapping operator.

According to an embodiment, at least one tone mapping operator is associated with a specification of target display characteristics.

A fourth aspect relates to an apparatus comprising

at least one processor and at least one memory, said at least one memory stored with code thereon, which when executed by said at least one processor, causes the apparatus to perform at least

providing a high dynamic range (HDR) video representation or information relating to the HDR video representation; and

providing a bitstream comprising one or more tone mapping operators and an indication of at least one tone mapping operator to be applied to said HDR video representation.

These and other aspects of the invention and the embodiments related thereto will become apparent in view of the detailed disclosure of the embodiments further below

### BRIEF DESCRIPTION OF THE DRAWINGS

For better understanding of the present invention, reference will now be made by way of example to the accompanying drawings in which:

FIG. 1 shows schematically an electronic device employing embodiments of the invention;

FIG. 2 shows schematically a user equipment suitable for employing embodiments of the invention;

FIG. 3 further shows schematically electronic devices employing embodiments of the invention connected using wireless and wired network connections;

FIG. 4 shows schematically an encoder suitable for implementing embodiments of the invention;

FIG. 5 shows a flow chart of a decoding operation according to an embodiment of the invention;

FIG. 6 shows a flow chart of a bitstream compiling according to an embodiment of the invention; and

FIG. 7 shows a schematic diagram of a decoder suitable for implementing embodiments of the invention.

### DETAILED DESCRIPTION OF SOME EXAMPLE EMBODIMENTS

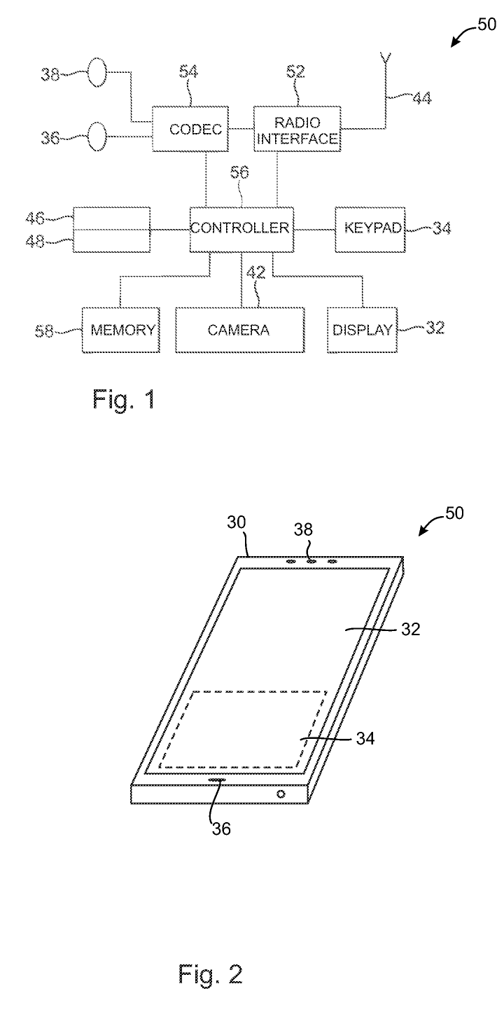

The following describes in further detail suitable apparatus and possible mechanisms for HDR/LDR modifications. In this regard reference is first made to FIGS. 1 and 2, where FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding.

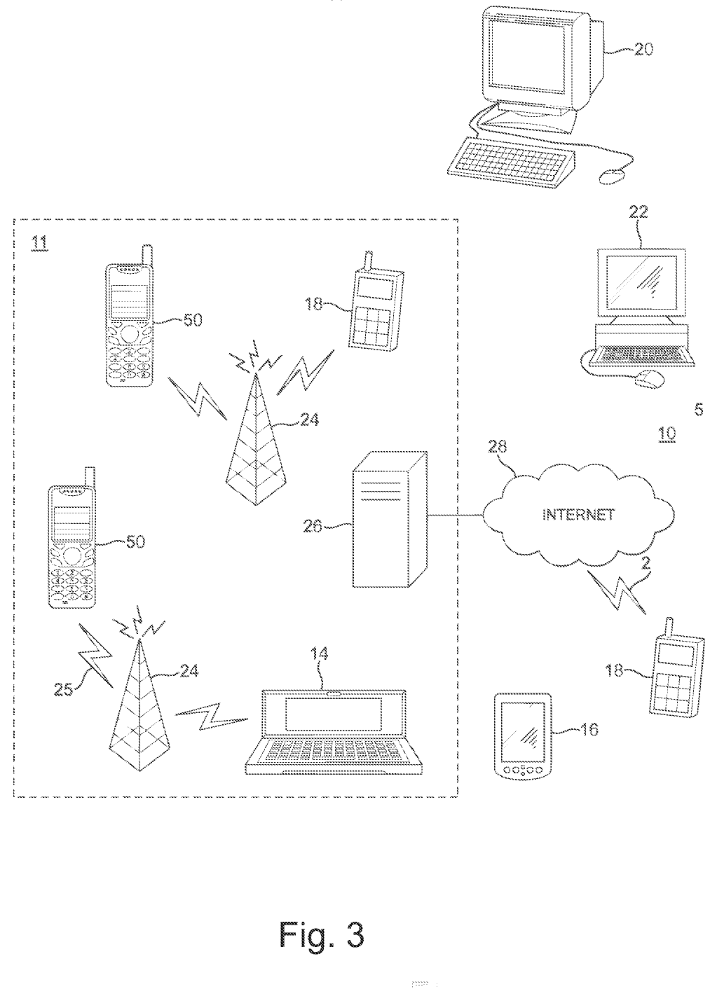

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Typically, each media type or media coding format has a dedicated RTP payload format.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver may group packets by synchronization source for playback. Examples of synchronization sources include the sender of a stream of packets derived from a signal source such as a microphone or a camera, or an RTP mixer. Each RTP stream is identified by a SSRC that is unique within the RTP session. An RTP stream may be regarded as a logical channel.

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically encoder discards some information in the original video sequence in order to represent the video in a more compact form (that is, at lower bitrate). A video encoder may be used to encode an image sequence, as defined subsequently, and a video decoder may be used to decode a coded image sequence. A video encoder or an intra coding part of a video encoder or an image encoder may be used to encode an image, and a video decoder or an inter decoding part of a video decoder or an image decoder may be used to decode a coded image.

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

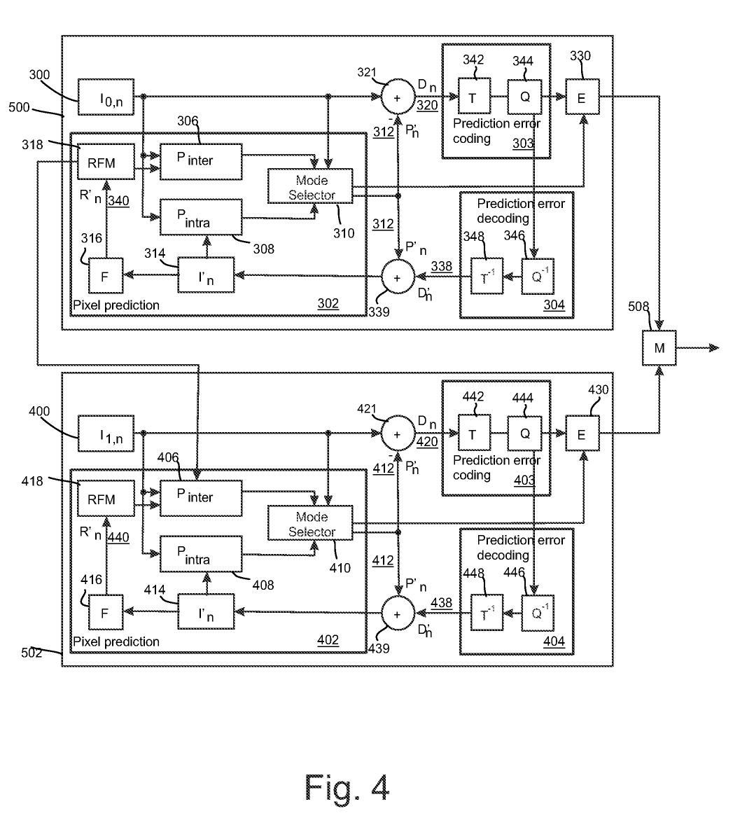

FIG. 4 shows a block diagram of a video encoder suitable for employing embodiments of the invention. FIG. 4 presents an encoder for two layers, but it would be appreciated that presented encoder could be similarly simplified to encode only one layer or extended to encode more than two layers. FIG. 4 illustrates an embodiment of a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives 300 base layer images of a video stream to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images of a video stream to be encoded at both the inter-predictor 406 (which determines the difference between the image and a motion compensated reference frame 418) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to a filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

Version 1 of the High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Version 2 of H.265/HEVC included scalable, multiview, and fidelity range extensions, which may be abbreviated SHVC, MV-HEVC, and REXT, respectively. Version 2 of H.265/HEVC was published as ITU-T Recommendation H.265 (10/2014) and is likely to be published as Edition 2 of ISO/IEC 23008-2 in 2015. There are currently ongoing standardization projects to develop further extensions to H.265/HEVC, including three-dimensional and screen content coding extensions, which may be abbreviated 3D-HEVC and SCC, respectively.

SHVC, MV-HEVC, and 3D-HEVC use a common basis specification, specified in Annex F of the version 2 of the HEVC standard. This common basis comprises for example high-level syntax and semantics e.g. specifying some of the characteristics of the layers of the bitstream, such as inter-layer dependencies, as well as decoding processes, such as reference picture list construction including inter-layer reference pictures and picture order count derivation for multi-layer bitstream. Annex F may also be used in potential subsequent multi-layer extensions of HEVC. It is to be understood that even though a video encoder, a video decoder, encoding methods, decoding methods, bitstream structures, and/or embodiments may be described in the following with reference to specific extensions, such as SHVC and/or MV-HEVC, they are generally applicable to any multi-layer extensions of HEVC, and even more generally to any multi-layer video coding scheme.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in HEVC—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

In the description of existing standards as well as in the description of example embodiments, a syntax element may be defined as an element of data represented in the bitstream. A syntax structure may be defined as zero or more syntax elements present together in the bitstream in a specified order. In the description of existing standards as well as in the description of example embodiments, a phrase “by external means” or “through external means” may be used. For example, an entity, such as a syntax structure or a value of a variable used in the decoding process, may be provided “by external means” to the decoding process. The phrase “by external means” may indicate that the entity is not included in the bitstream created by the encoder, but rather conveyed externally from the bitstream for example using a control protocol. It may alternatively or additionally mean that the entity is not created by the encoder, but may be created for example in the player or decoding control logic or alike that is using the decoder. The decoder may have an interface for inputting the external means, such as variable values.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issue, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles. A tier may be defined as specified category of level constraints imposed on values of the syntax elements in the bitstream, where the level constraints are nested within a tier and a decoder conforming to a certain tier and level would be capable of decoding all bitstreams that conform to the same tier or the lower tier of that level or any level below it.

The elementary unit for the input to an H.264/AVC or HEVC encoder and the output of an H.264/AVC or HEVC decoder, respectively, is a picture. A picture given as an input to an encoder may also referred to as a source picture, and a picture decoded by a decoded may be referred to as a decoded picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of H.264/AVC and/or HEVC. A component may be defined as an array or single sample from one of the three sample arrays arrays (luma and two chroma) or the array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays. Chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples.

In some video codecs, such as High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size may be named as LCU (largest coding unit) or coding tree unit (CTU) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

Each TU can be associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO.

In typical video codecs the motion information is indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index is typically predicted from adjacent blocks and/or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

Typical video codecs enable the use of uni-prediction, where a single prediction block is used for a block being (de)coded, and bi-prediction, where two prediction blocks are combined to form the prediction for a block being (de)coded. Some video codecs enable weighted prediction, where the sample values of the prediction blocks are weighted prior to adding residual information. For example, multiplicative weighting factor and an additive offset which can be applied. In explicit weighted prediction, enabled by some video codecs, a weighting factor and offset may be coded for example in the slice header for each allowable reference picture index. In implicit weighted prediction, enabled by some video codecs, the weighting factors and/or offsets are not coded but are derived e.g. based on the relative picture order count (POC) distances of the reference pictures.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR, (1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

An elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. The header for SVC and MVC NAL units may additionally contain various indications related to the scalability and multiview hierarchy.

In HEVC, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1−1. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to TID does not use any picture having a TemporalId greater than TID as inter prediction reference. A sub-layer or a temporal sub-layer may be defined to be a temporal scalable layer of a temporal scalable bitstream, consisting of VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, VCL NAL units contain syntax elements representing one or more CU.

In H.264/AVC, a coded slice NAL unit can be indicated to be a coded slice in an Instantaneous Decoding Refresh (IDR) picture or coded slice in a non-IDR picture.

In HEVC, a coded slice NAL unit can be indicated to be one of the following types:

| | Name of | Content of NAL unit and |
|---|---|---|
| nal_unit_type | nal_unit_type | RBSP syntax structure |
| 0, | TRAIL_N, | Coded slice segment of a non- |
| 1 | TRAIL_R | TSA, non-STSA trailing picture |
| | | slice_segment_layer_rbsp( ) |
| 2, | TSA_N, | Coded slice segment of a TSA |
| 3 | TSA_R | picture |
| | | slice_segment_layer_rbsp( ) |
| 4, | STSA_N, | Coded slice segment of an STSA |
| 5 | STSA_R | picture |
| | | slice_layer_rbsp( ) |
| 6, | RADL_N, | Coded slice segment of a RADL |
| 7 | RADL_R | picture |
| | | slice_layer_rbsp( ) |
| 8, | RASL_N, | Coded slice segment of a RASL |
| 9 | RASL_R, | picture |
| | | slice_layer_rbsp( ) |
| 10, | RSV_VCL_N10 | Reserved // reserved non-RAP |
| 12, | RSV_VCL_N12 | non-reference VCL NAL unit |
| 14 | RSV_VCL_N14 | types |
| 11, | RSV_VCL_R11 | Reserved // reserved non-RAP |
| 13, | RSV_VCL_R13 | reference VCL NAL unit types |
| 15 | RSV_VCL_R15 | |
| 16, | BLA_W_LP | Coded slice segment of a BLA |
| 17, | BLA_W_DLP (a.k.a. | picture |
| 18 | IDR_W_RADL) | slice_segment_layer_rbsp( ) |
| | BLA_N_LP | |
| 19, | IDR_W_DLP (a.k.a. | Coded slice segment of an IDR |
| 20 | IDR_W_RADL) | picture |
| | IDR_N_LP | slice_segment_layer_rbsp( ) |
| 21 | CRA_NUT | Coded slice segment of a CRA |
| | | picture |
| | | slice_segment_layer_rbsp( ) |
| 22, | RSV_IRAP_VCL22 . . . | Reserved // reserved RAP VCL |
| 23 | RSV_IRAP_VCL23 | NAL unit types |
| 24 . . . 31 | RSV_VCL24 . . . | Reserved // reserved non-RAP |
| | RSV_VCL31 | VCL NAL unit types |

In HEVC, abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture.

A Random Access Point (RAP) picture, which may also be referred to as an intra random access point (IRAP) picture, is a picture where each slice or slice segment has nal_unit_type in the range of 16 to 23, inclusive. A IRAP picture in an independent layer contains only intra-coded slices. An IRAP picture belonging to a predicted layer with nuh_layer_id value currLayerId may contain P, B, and I slices, cannot use inter prediction from other pictures with nuh_layer_id equal to currLayerId, and may use inter-layer prediction from its direct reference layers. In the present version of HEVC, an IRAP picture may be a BLA picture, a CRA picture or an IDR picture. The first picture in a bitstream containing a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that precede the IRAP picture in decoding order. The IRAP picture belonging to a predicted layer with nuh_layer_id value currLayerId and all subsequent non-RASL pictures with nuh_layer_id equal to currLayerId in decoding order can be correctly decoded without performing the decoding process of any pictures with nuh_layer_id equal to currLayerId that precede the IRAP picture in decoding order, when the necessary parameter sets are available when they need to be activated and when the decoding of each direct reference layer of the layer with nuh_layer_id equal to currLayerId has been initialized (i.e. when LayerinitializedFlag[refLayerId] is equal to 1 for refLayerId equal to all nuh_layer_id values of the direct reference layers of the layer with nuh_layer_id equal to currLayerId). There may be pictures in a bitstream that contain only intra-coded slices that are not TRAP pictures.

In HEVC a CRA picture may be the first picture in the bitstream in decoding order, or may appear later in the bitstream. CRA pictures in HEVC allow so-called leading pictures that follow the CRA picture in decoding order but precede it in output order. Some of the leading pictures, so-called RASL pictures, may use pictures decoded before the CRA picture as a reference. Pictures that follow a CRA picture in both decoding and output order are decodable if random access is performed at the CRA picture, and hence clean random access is achieved similarly to the clean random access functionality of an IDR picture.

A CRA picture may have associated RADL or RASL pictures. When a CRA picture is the first picture in the bitstream in decoding order, the CRA picture is the first picture of a coded video sequence in decoding order, and any associated RASL pictures are not output by the decoder and may not be decodable, as they may contain references to pictures that are not present in the bitstream.

A leading picture is a picture that precedes the associated RAP picture in output order. The associated RAP picture is the previous RAP picture in decoding order (if present). A leading picture is either a RADL picture or a RASL picture.

All RASL pictures are leading pictures of an associated BLA or CRA picture. When the associated RAP picture is a BLA picture or is the first coded picture in the bitstream, the RASL picture is not output and may not be correctly decodable, as the RASL picture may contain references to pictures that are not present in the bitstream. However, a RASL picture can be correctly decoded if the decoding had started from a RAP picture before the associated RAP picture of the RASL picture. RASL pictures are not used as reference pictures for the decoding process of non-RASL pictures. When present, all RASL pictures precede, in decoding order, all trailing pictures of the same associated RAP picture. In some drafts of the HEVC standard, a RASL picture was referred to a Tagged for Discard (TFD) picture.

All RADL pictures are leading pictures. RADL pictures are not used as reference pictures for the decoding process of trailing pictures of the same associated RAP picture. When present, all RADL pictures precede, in decoding order, all trailing pictures of the same associated RAP picture. RADL pictures do not refer to any picture preceding the associated RAP picture in decoding order and can therefore be correctly decoded when the decoding starts from the associated RAP picture. In some drafts of the HEVC standard, a RADL picture was referred to a Decodable Leading Picture (DLP).

When a part of a bitstream starting from a CRA picture is included in another bitstream, the RASL pictures associated with the CRA picture might not be correctly decodable, because some of their reference pictures might not be present in the combined bitstream. To make such a splicing operation straightforward, the NAL unit type of the CRA picture can be changed to indicate that it is a BLA picture. The RASL pictures associated with a BLA picture may not be correctly decodable hence are not be output/displayed. Furthermore, the RASL pictures associated with a BLA picture may be omitted from decoding.

A BLA picture may be the first picture in the bitstream in decoding order, or may appear later in the bitstream. Each BLA picture begins a new coded video sequence, and has similar effect on the decoding process as an IDR picture. However, a BLA picture contains syntax elements that specify a non-empty reference picture set. When a BLA picture has nal_unit_type equal to BLA_W_LP, it may have associated RASL pictures, which are not output by the decoder and may not be decodable, as they may contain references to pictures that are not present in the bitstream. When a BLA picture has nal_unit_type equal to BLA_W_LP, it may also have associated RADL pictures, which are specified to be decoded. When a BLA picture has nal_unit_type equal to BLA_W_DLP, it does not have associated RASL pictures but may have associated RADL pictures, which are specified to be decoded. When a BLA picture has nal_unit_type equal to BLA_N_LP, it does not have any associated leading pictures.

An IDR picture having nal_unit_type equal to IDR_N_LP does not have associated leading pictures present in the bitstream. An IDR picture having nal_unit_type equal to IDR_W_LP does not have associated RASL pictures present in the bitstream, but may have associated RADL pictures in the bitstream.

When the value of nal_unit_type is equal to TRAIL_N, TSA_N, STSA_N, RADL_N, RASL_N, RSV_VCL_N10, RSV_VCL_N12, or RSV_VCL_N14, the decoded picture is not used as a reference for any other picture of the same temporal sub-layer. That is, in HEVC, when the value of nal_unit_type is equal to TRAIL_N, TSA_N, STSA_N, RADL_N, RASL_N, RSV_VCL_N10, RSV_VCL_N12, or RSV_VCL_N14, the decoded picture is not included in any of RefPicSetStCurrBefore, RefPicSetStCurrAfter and RefPicSetLtCurr of any picture with the same value of TemporalId. A coded picture with nal_unit_type equal to TRAIL_N, TSA_N, STSA_N, RADL_N, RASL_N, RSV_VCL_N10, RSV_VCL_N12, or RSV_VCL_N14 may be discarded without affecting the decodability of other pictures with the same value of TemporalId.

A trailing picture may be defined as a picture that follows the associated RAP picture in output order. Any picture that is a trailing picture does not have nal_unit_type equal to RADL_N, RADL_R, RASL_N or RASL_R. Any picture that is a leading picture may be constrained to precede, in decoding order, all trailing pictures that are associated with the same RAP picture. No RASL pictures are present in the bitstream that are associated with a BLA picture having nal_unit_type equal to BLA_W_DLP or BLA_N_LP. No RADL pictures are present in the bitstream that are associated with a BLA picture having nal_unit_type equal to BLA_N_LP or that are associated with an IDR picture having nal_unit_type equal to IDR_N_LP. Any RASL picture associated with a CRA or BLA picture may be constrained to precede any RADL picture associated with the CRA or BLA picture in output order. Any RASL picture associated with a CRA picture may be constrained to follow, in output order, any other RAP picture that precedes the CRA picture in decoding order.

In HEVC there are two picture types, the TSA and STSA picture types that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In HEVC a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

Video bitstreams may include or may be accompanied by metadata about the color volume and related properties of the represented video content. Many times such metadata is optionally present in or accompanies the bitstream. Such metadata may include but is not limited to the following:
Color primaries indicate the chromaticity coordinates of the source primaries. In HEVC, this information may be included in VUI.
Transfer characteristics indicate the opto-electronic transfer characteristic of the associated picture. In HEVC, this information may be included in VUI.
Matrix coefficients can be used in deriving luma and chroma signals from the green, blue, and red, or Y, Z, and X primaries of the associated picture. In HEVC, this information may be included in VUI.
The black level and range of the luma and chroma signals. For example, it may be indicated that the luma values less than or equal to 16 represent black (when luma samples are represented by 8 bits). In HEVC, this information may be included in VUI.

In HEVC, a video parameter set (VPS) may be defined as a syntax structure containing syntax elements that apply to zero or more entire coded video sequences as determined by the content of a syntax element found in the SPS referred to by a syntax element found in the PPS referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present. In HEVC, the base VPS may be considered to comprise the video_parameter_set_rbsp( ) syntax structure without the vps_extension( ) syntax structure. The video_parameter_set_rbsp( ) syntax structure was primarily specified already for HEVC version 1 and includes syntax elements which may be of use for base layer decoding. In HEVC, the VPS extension may be considered to comprise the vps_extension( ) syntax structure. The vps_extension( ) syntax structure was specified in HEVC version 2 primarily for multi-layer extensions and comprises syntax elements which may be of use for decoding of one or more non-base layers, such as syntax elements indicating layer dependency relations.

H.264/AVC and HEVC syntax allows many instances of parameter sets, and each instance is identified with a unique identifier. In order to limit the memory usage needed for parameter sets, the value range for parameter set identifiers has been limited. In H.264/AVC and HEVC, each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

Out-of-band transmission, signaling or storage can additionally or alternatively be used for other purposes than tolerance against transmission errors, such as ease of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) may be used in claims and described embodiments to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream.

A parameter set may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In HEVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In HEVC, no redundant coded picture has been specified.

In H.264/AVC, an access unit (AU) comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

In HEVC, a coded picture may be defined as a coded representation of a picture containing all coding tree units of the picture. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units.

It may be required that coded pictures appear in certain order within an access unit. For example a coded picture with nuh_layer_id equal to nuhLayerIdA may be required to precede, in decoding order, all coded pictures with nuh_layer_id greater than nuhLayerIdA in the same access unit.

In HEVC, a picture unit may be defined as a set of NAL units that contain all VCL NAL units of a coded picture and their associated non-VCL NAL units. An associated VCL NAL unit for a non-VCL NAL unit may be defined as the preceding VCL NAL unit, in decoding order, of the non-VCL NAL unit for certain types of non-VCL NAL units and the next VCL NAL unit, in decoding order, of the non-VCL NAL unit for other types of non-VCL NAL units. An associated non-VCL NAL unit for a VCL NAL unit may be defined to be the a non-VCL NAL unit for which the VCL NAL unit is the associated VCL NAL unit. For example, in HEVC, an associated VCL NAL unit may be defined as the preceding VCL NAL unit in decoding order for a non-VCL NAL unit with nal_unit_type equal to EOS_NUT, EOB_NUT, FD_NUT, or SUFFIX_SEI_NUT, or in the ranges of RSV_NVCL45 . . . RSV_NVCL47 or UNSPEC56 . . . UNSPEC63; or otherwise the next VCL NAL unit in decoding order.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0.

In H.264/AVC, a coded video sequence is defined to be a sequence of consecutive access units in decoding order from an IDR access unit, inclusive, to the next IDR access unit, exclusive, or to the end of the bitstream, whichever appears earlier.

In HEVC, a coded video sequence (CVS) may be defined, for example, as a sequence of access units that consists, in decoding order, of an TRAP access unit with NoRaslOutputFlag equal to 1, followed by zero or more access units that are not IRAP access units with NoRaslOutputFlag equal to 1, including all subsequent access units up to but not including any subsequent access unit that is an IRAP access unit with NoRaslOutputFlag equal to 1. An IRAP access unit may be defined as an access unit in which the base layer picture is an IRAP picture. The value of NoRaslOutputFlag is equal to 1 for each IDR picture, each BLA picture, and each IRAP picture that is the first picture in that particular layer in the bitstream in decoding order, is the first IRAP picture that follows an end of sequence NAL unit having the same value of nuh_layer_id in decoding order. In multi-layer HEVC, the value of NoRaslOutputFlag is equal to 1 for each IRAP picture when its nuh_layer_id is such that LayerInitializedFlag[nuh_layer_id] is equal to 0 and LayerinitializedFlag[refLayerId] is equal to 1 for all values of refLayerId equal to IdDirectRefLayer[nuh_layer_id][j], where j is in the range of 0 to NumDirectRefLayers[nuh_layer_id]−1, inclusive. Otherwise, the value of NoRaslOutputFlag is equal to HandleCraAsBlaFlag. NoRaslOutputFlag equal to 1 has an impact that the RASL pictures associated with the TRAP picture for which the NoRaslOutputFlag is set are not output by the decoder. There may be means to provide the value of HandleCraAsBlaFlag to the decoder from an external entity, such as a player or a receiver, which may control the decoder. HandleCraAsBlaFlag may be set to 1 for example by a player that seeks to a new position in a bitstream or tunes into a broadcast and starts decoding and then starts decoding from a CRA picture. When HandleCraAsBlaFlag is equal to 1 for a CRA picture, the CRA picture is handled and decoded as if it were a BLA picture.

In HEVC, a coded video sequence may additionally or alternatively (to the specification above) be specified to end, when a specific NAL unit, which may be referred to as an end of sequence (EOS) NAL unit, appears in the bitstream and has nuh_layer_id equal to 0.

In HEVC, a coded video sequence group (CVSG) may be defined, for example, as one or more consecutive CVSs in decoding order that collectively consist of an TRAP access unit that activates a VPS RBSP firstVpsRbsp that was not already active followed by all subsequent access units, in decoding order, for which firstVpsRbsp is the active VPS RBSP up to the end of the bitstream or up to but excluding the access unit that activates a different VPS RBSP than firstVpsRbsp, whichever is earlier in decoding order.

A Structure of Pictures (SOP) may be defined as one or more coded pictures consecutive in decoding order, in which the first coded picture in decoding order is a reference picture at the lowest temporal sub-layer and no coded picture except potentially the first coded picture in decoding order is a RAP picture. All pictures in the previous SOP precede in decoding order all pictures in the current SOP and all pictures in the next SOP succeed in decoding order all pictures in the current SOP. A SOP may represent a hierarchical and repetitive inter prediction structure. The term group of pictures (GOP) may sometimes be used interchangeably with the term SOP and having the same semantics as the semantics of SOP.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC.

Scalable video coding may refer to coding structure where one bitstream can contain multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e., the frame rate), the spatial resolution, or simply the quality of the video content represented by another layer or part thereof. Each layer together with all its dependent layers is one representation of the video signal, for example, at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: Base layer pictures are coded at a lower resolution (i.e. have fewer samples) than enhancement layer pictures. Spatial scalability and quality scalability, particularly its coarse-grain scalability type, may sometimes be considered the same type of scalability.
Bit-depth scalability: Base layer pictures are coded at lower bit-depth (e.g. 8 bits) than enhancement layer pictures (e.g. 10 or 12 bits).
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
View scalability, which may also be referred to as multiview coding. The base layer represents a first view, whereas an enhancement layer represents a second view.
Depth scalability, which may also be referred to as depth-enhanced coding. A layer or some layers of a bitstream may represent texture view(s), while other layer or layers may represent depth view(s).
Region-of-interest scalability. An enhancement layer provides an enhancement of a region of the reference layer.
Interlaced-to-progressive scalability (also known as field-to-frame scalability): coded interlaced source content material of the base layer is enhanced with an enhancement layer to represent progressive source content. The coded interlaced source content in the base layer may comprise coded fields, coded frames representing field pairs, or a mixture of them. In the interlace-to-progressive scalability, the base-layer picture may be resampled so that it becomes a suitable reference picture for one or more enhancement-layer pictures.
Hybrid codec scalability (also known as coding standard scalability): In hybrid codec scalability, the bitstream syntax, semantics and decoding process of the base layer and the enhancement layer are specified in different video coding standards. Thus, base layer pictures are coded according to a different coding standard or format than enhancement layer pictures. For example, the base layer may be coded with H.264/AVC and an enhancement layer may be coded with an HEVC extension.

It should be understood that many of the scalability types may be combined and applied together. For example color gamut scalability and bit-depth scalability may be combined.

The term layer may be used in context of any type of scalability, including view scalability and depth enhancements. An enhancement layer may refer to any type of an enhancement, such as SNR, spatial, multiview, depth, bit-depth, chroma format, and/or color gamut enhancement. A base layer may refer to any type of a base video sequence, such as a base view, a base layer for SNR/spatial scalability, or a texture base view for depth-enhanced video coding.

Scalability may be enabled in two basic ways. Either by introducing new coding modes for performing prediction of pixel values or syntax from lower layers of the scalable representation or by placing the lower layer pictures to a reference picture buffer (e.g. a decoded picture buffer, DPB) of the higher layer. The first approach may be more flexible and thus may provide better coding efficiency in most cases. However, the second, reference frame based scalability, approach may be implemented efficiently with minimal changes to single layer codecs while still achieving majority of the coding efficiency gains available. Essentially a reference frame based scalability codec may be implemented by utilizing the same hardware or software implementation for all the layers, just taking care of the DPB management by external means.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

Scalable video (de)coding may be realized with a concept known as single-loop decoding, where decoded reference pictures are reconstructed only for the highest layer being decoded while pictures at lower layers may not be fully decoded or may be discarded after using them for inter-layer prediction. In single-loop decoding, the decoder performs motion compensation and full picture reconstruction only for the scalable layer desired for playback (called the “desired layer” or the “target layer”), thereby reducing decoding complexity when compared to multi-loop decoding. All of the layers other than the desired layer do not need to be fully decoded because all or part of the coded picture data is not needed for reconstruction of the desired layer. However, lower layers (than the target layer) may be used for inter-layer syntax or parameter prediction, such as inter-layer motion prediction. Additionally or alternatively, lower layers may be used for inter-layer intra prediction and hence intra-coded blocks of lower layers may have to be decoded. Additionally or alternatively, inter-layer residual prediction may be applied, where the residual information of the lower layers may be used for decoding of the target layer and the residual information may need to be decoded or reconstructed. In some coding arrangements, a single decoding loop is needed for decoding of most pictures, while a second decoding loop may be selectively applied to reconstruct so-called base representations (i.e. decoded base layer pictures), which may be needed as prediction references but not for output or display.

In multi-layer HEVC extensions (here referred to as MV-HEVC/SHVC), it may be indicated in the VPS that a layer with layer identifier value greater than 0 has no direct reference layers, i.e. that the layer is not inter-layer predicted from any other layer. In other words, an MV-HEVC/SHVC bitstream may contain layers that are independent of each other, which may be referred to as simulcast layers.

In multi-layer HEVC extensions, it may be indicated in the VPS which scalability dimensions may be present in the bitstream from a set of dimensions comprising but not limited to multiview scalability, spatial/quality scalability, and auxiliary picture layers. Each scalability dimension may be associated with a scalability identifier type, for example view order index, dependency identifier (DependencyId), and auxiliary identifier (AuxId), respectively to the above listed scalability dimensions. VPS may indicate the scalability identifier value for each scalability identifier type a layer (with particular layer identifier value, i.e. nuh_layer_id value). That is, VPS may provide information indicative of the mapping of a layer identifier value of a layer with a set of scalability identifier values for that layer.

Enhancement layers or layers with a layer identifier value greater than 0 may be indicated to contain auxiliary video complementing the base layer or other layers. For example, in MV-HEVC, auxiliary pictures may be encoded in a bitstream using auxiliary picture layers. An auxiliary picture layer is associated with its own scalability dimension value, AuxId (similarly to e.g. view order index). Layers with AuxId greater than 0 contain auxiliary pictures. A layer carries only one type of auxiliary pictures, and the type of auxiliary pictures included in a layer may be indicated by its AuxId value. In other words, AuxId values may be mapped to types of auxiliary pictures. For example, AuxId equal to 1 may indicate alpha planes and AuxId equal to 2 may indicate depth pictures. An auxiliary picture may be defined as a picture that has no normative effect on the decoding process of primary pictures. In other words, primary pictures (with AuxId equal to 0) may be constrained not to predict from auxiliary pictures. An auxiliary picture may predict from a primary picture, although there may be constraints disallowing such prediction, for example based on the AuxId value. SEI messages may be used to convey more detailed characteristics of auxiliary picture layers, such as the depth range represented by a depth auxiliary layer.

Different types of auxiliary pictures may be used including but not limited to the following: Depth pictures; Alpha pictures; Overlay pictures; and Label pictures. In Depth pictures a sample value represents disparity between the viewpoint (or camera position) of the depth picture or depth or distance. In Alpha pictures (a.k.a. alpha planes and alpha matte pictures) a sample value represents transparency or opacity. Alpha pictures may indicate for each pixel a degree of transparency or equivalently a degree of opacity. Alpha pictures may be monochrome pictures or the chroma components of alpha pictures may be set to indicate no chromaticity (e.g. 0 when chroma samples values are considered to be signed or 128 when chroma samples values are 8-bit and considered to be unsigned). Overlay pictures may be overlaid on top of the primary pictures in displaying. Overlay pictures may contain several regions and background, where all or a subset of regions may be overlaid in displaying and the background is not overlaid. Label pictures contain different labels for different overlay regions, which can be used to identify single overlay regions.

SHVC enables the use of weighted prediction or a color-mapping process based on a 3D lookup table (LUT) for color gamut scalability. The 3D LUT approach may be described as follows. The sample value range of each color components may be first split into two ranges, forming up to 2×2×2 octants, and then the luma ranges can be further split up to four parts, resulting into up to 8×2×2 octants. Within each octant, a cross color component linear model is applied to perform color mapping. For each octant, four vertices are encoded into and/or decoded from the bitstream to represent a linear model within the octant. The color-mapping table is encoded into and/or decoded from the bitstream separately for each color component. Color mapping may be considered to involve three steps: First, the octant to which a given reference-layer sample triplet (Y, Cb, Cr) belongs is determined. Second, the sample locations of luma and chroma may be aligned through applying a color component adjustment process. Third, the linear mapping specified for the determined octant is applied. The mapping may have cross-component nature, i.e. an input value of one color component may affect the mapped value of another color component. Additionally, if inter-layer resampling is also required, the input to the resampling process is the picture that has been color-mapped. The color-mapping may (but needs not to) map samples of a first bit-depth to samples of another bit-depth.

The spatial correspondence of a reference-layer picture and an enhancement-layer picture may be inferred or may be indicated with one or more types of so-called reference layer location offsets. In HEVC, reference layer location offsets may be included in the PPS by the encoder and decoded from the PPS by the decoder. Reference layer location offsets may be used for but are not limited to achieving ROI scalability. Reference layer location offsets may comprise one or more of scaled reference layer offsets, reference region offsets, and resampling phase sets. Scaled reference layer offsets may be considered to specify the horizontal and vertical offsets between the sample in the current picture that is collocated with the top-left luma sample of the reference region in a decoded picture in a reference layer and the horizontal and vertical offsets between the sample in the current picture that is collocated with the bottom-right luma sample of the reference region in a decoded picture in a reference layer. Another way is to consider scaled reference layer offsets to specify the positions of the corner samples of the upsampled reference region relative to the respective corner samples of the enhancement layer picture. The scaled reference layer offset values may be signed. Reference region offsets may be considered to specify the horizontal and vertical offsets between the top-left luma sample of the reference region in the decoded picture in a reference layer and the top-left luma sample of the same decoded picture as well as the horizontal and vertical offsets between the bottom-right luma sample of the reference region in the decoded picture in a reference layer and the bottom-right luma sample of the same decoded picture. The reference region offset values may be signed. A resampling phase set may be considered to specify the phase offsets used in resampling process of a direct reference layer picture. Different phase offsets may be provided for luma and chroma components.

Each point value in a digital representation of two-dimensional video is specified in a ‘color space’. As described above, commonly used color spaces include ‘YUV’ and ‘RGB’. A particular point value in a particular color space is fully described by numeric values for each component in the color space. For example, in the YUV color space, a point value is fully described by numeric values for each of the three Y, U, and V components.

Numeric values for uncompressed digital representations of video may be integers or floating point numbers. Video codecs typically use integer values to facilitate greater compression efficiency. Furthermore, the maximum value of each integer value is typically limited, again to facilitate greater compression efficiency. The number of bits required to represent the range of permitted integer values is commonly referred to as the ‘bit depth’ of the video representation. A particular video codec may have operating modes which permit it to operate at multiple bit depths, thus a particular video codec is not necessarily associated with a single bit depth. These operating modes may be defined as ‘profiles’ of the video codec.

Typical video codecs, including H.264/AVC and HEVC, have at least one operating mode where the digital representation of video has a bit depth of 8, or ‘8-bit video’. Newer video codecs, including H.264/AVC and HEVC, have additional operating modes for greater bit depths, including 10-bit video.

The human eye can typically perceive a range of brightness equivalent to approximately five orders of magnitude. However, media such as the printed page can only span approximately two orders of magnitude. Traditional video display devices, such as cathode ray tubes (CRT) and liquid crystal displays (LCD) have similar limitations. This range of brightness is called the ‘dynamic range’.

A traditional way of representing the color of each pixel is a combination of the color space components RGB or YUV or YCrCb. Typically 8 bits are allocated for each component, yielding 24 bits per pixel (24 bpp). This is called the RGB8 or YUV8 format. It is also possible to use formats like RGB565 or YUV844 (8 bits used only for luma component, 4 bits for chroma components) that sacrifice color gamut in favor of using less memory space. A problem with the traditional formats of representing colors is that they provide a rather limited dynamic range for colors, for example in comparison to a human's capability of simultaneously perceiving luminance across over 4 dB (i.e. a contrast ratio of 1:10⁴=1:10 000). Accordingly, video representations created with these traditional methods are generally called low dynamic range (LDR) representations.

To maximize compression efficiency, traditional video codecs such as H.264/AVC and HEVC have been designed to compress video with the typical video display devices in mind, that is, those with a low dynamic range (LDR), or covering approximately two orders of magnitude.

It is desirable to display video in a manner that exploits the capabilities of the human eye in order to achieve a more visually pleasing experience for the viewer. Thus it is desirable to display video with a high dynamic range (HDR), or up to five orders of magnitude.

High dynamic range (HDR) formats have been developed in order to meet the demand for better image quality in image/video representations. The HDR image formats are able to represent the entire dynamic range of luminance in the real world. The HDR image format may use, for example, a 12-bit, a 16-bit or a 32-bit floating-point representation for the color components. For video coding, the 12-bit or the 16-bit format is sufficient for most purposes, yielding a practical bit rate of 36 or 48 bpp, correspondingly. Similar to the LDR formats, a HDR format can be used, where only the luma component uses the 12 bit representation and the chroma components use less, e.g. eight bits in order to improve the compression efficiency.

Typical video codecs such as H.264/AVC and HEVC may be used to compress video of any dynamic range by interpreting the maximum coded value as corresponding to a greater or lower luminance (in candelas/m²; i.e. c/m², or ‘nits’).

When dynamic range is increased but bit depth remains the same, the difference between consecutive integer values in the digital representation of the video (measured in absolute values of ‘nits’) increases. This large ‘step size’ results in an undesirable visual effect known as ‘banding’, where a region that the eye would typically perceive as a smooth gradient instead appears as series of bands with distinct boundaries or discontinuities. It furthermore leads to detail in the video being lost, which makes the experience less pleasing for the viewer. To prevent the problem of ‘banding’ and loss of detail when compressing HDR video, bit depth must be increased. Typically, at least 12-bit video is needed for HDR.

It is possible that a video content producer wishes to make content available for display on conventional (LDR) displays, but also wishes to exploit the enhanced capabilities of newer HDR displays. For that purpose, a single compressed representation of the video that can be used for both LDR and HDR displays may be useful.

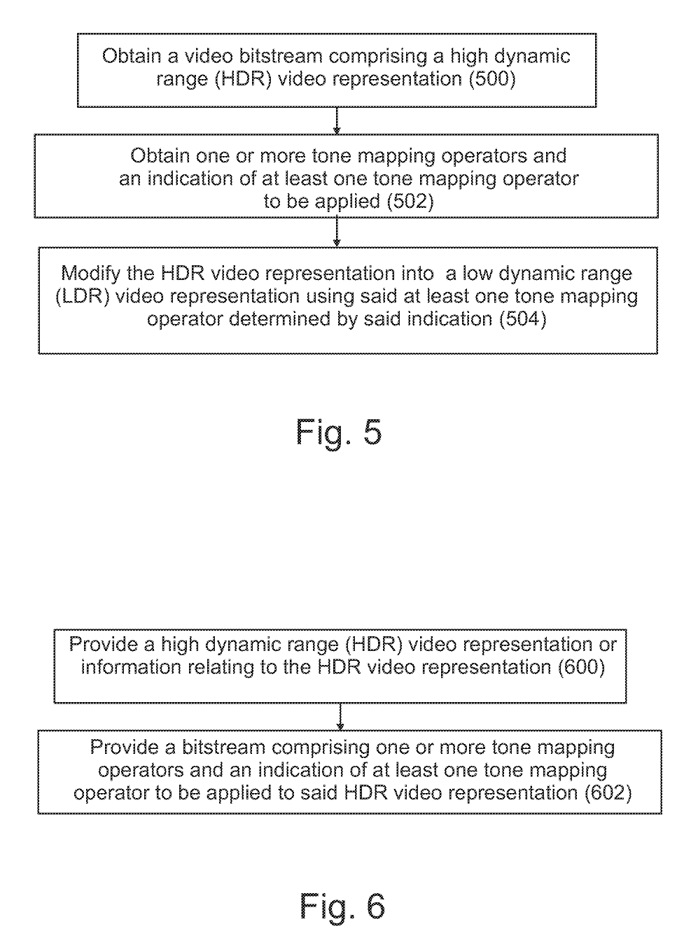

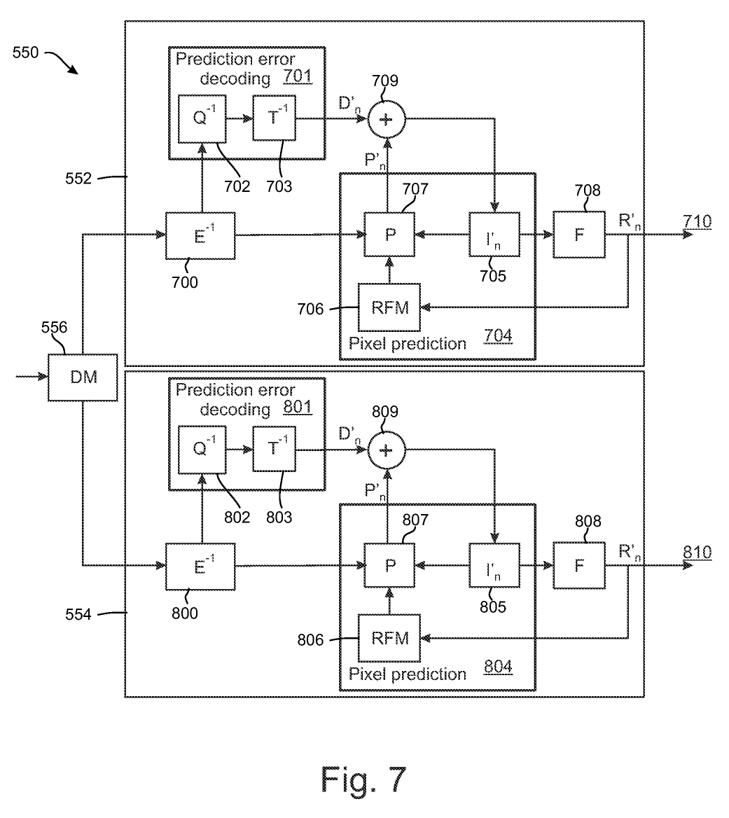

Now in order to at least alleviate the above problems, a method for modifying an HDR video representation into an LDR representation is presented hereinafter. In the method, which is disclosed in FIG. 5, a video bitstream comprising a high dynamic range (HDR) video representation is obtained (500) in a decoder or in another entity capable of carrying out the decoding operations. The decoder or another entity obtains (502), e.g. from said video bitstream or from a separate bitstream, one or more tone mapping operators and an indication of at least one tone mapping operator to be applied to said HDR video representation. The decoder or another entity then modifies (504) the HDR video representation into a low dynamic range (LDR) video representation using said at least one tone mapping operator determined by said indication.

Thus, an HDR video representation is modified so as to enable to display it on a LDR-only capable display. Herein, one or more tone mapping operators (TMO), i.e. algorithms, are applied for converting an HDR video representation into a LDR video representation.

Tone mapping may be defined as image processing operation(s) that map one set of colors to another to approximate a representation of HDR images to an image representation having a more limited dynamic range. A significant number of tone mapping operators have been described, including Reinhard, Gastal, and Duiker. Each tone mapping operator has different characteristics that may suit it to specific types of video content. For example, some tone mapping operators enhance the detail in dark areas, and are thus most suited to low-light video. Importantly, it is not practical to designate a single tone mapping operator as being universally optimal.

A tone mapping operator may be a simple linear function that maps an HDR value into a LDR value. More complex tone mapping operators are locally adaptive, and base the function upon spatially varying characteristics of the video. When applied to a given video sample value, the tone mapping operator may take into account factors such as the average or variance of values surrounding the sample in question, any smoothness or discontinuities in the neighboring sample values, and other computed statistics.

In order to enable a decoder or a corresponding entity to modify an HDR video representation into an LDR representation, a bitstream comprising a specification for one or more tone mapping operations needs to be provided. A method for providing such a bitstream is illustrated in FIG. 6, wherein either an HDR video representation or information relating to the HDR video representation, such as one or more HDR metadata elements, is provided (600). An encoder or another entity capable of carrying out bitstream compilation operations provides (602) a bitstream comprising one or more tone mapping operators and an indication of at least one tone mapping operator to be applied to said HDR video representation. The bitstream may be a video bitstream comprising the HDR video representation, wherein the one or more tone mapping operators and an indication of at least one tone mapping operator to be applied to said HDR video representation may be provided in or along the video bitstream. The bitstream may be a separate bitstream, wherein the one or more tone mapping operators and an indication of at least one tone mapping operator to be applied to said HDR video representation may be provided with one or more HDR metadata elements for associating the tone mapping operators to the HDR video representation at the receiving end.

In the following, various embodiment relating to the tone mapping operators and an indication of at least one tone mapping operator to be applied to said HDR video representation, i.e. a specification of a tone mapping operator are described. The various embodiments may be equally applicable to the encoding and decoding processes unless otherwise indicated.

According to an embodiment, specification of a tone mapping operator includes the presence of one or more syntax elements in the bitstream, the syntax elements or their value(s) indicating a mathematical operation that should be applied, said mathematical operations belonging to a predefined list of tone mapping operators.

According to an embodiment, said syntax element is modified by means of an algorithm, the result of said algorithm indicating which one of said tone mapping operators is applied to said high dynamic range video representation.

According to an embodiment, the one or more tone mapping operators comprise a pre-defined list that is known to the decoder.

According to an embodiment, specification of a tone mapping operator includes, in addition to or instead of indicating and/or defining a mathematical operation, the presence of a look-up table in the bitstream to be used for substituting lower dynamic range and/or lower bit depth values for higher dynamic range and/or higher bit depth values present in the video bit stream. Said look-up table may be compressed by various means including run-length coding or arithmetic coding.

According to an embodiment, said look-up table may comprise only the Y component, i.e. is used to take an HDR Y value, e.g. a 12-bit value, as input and outputs an LDR Y value. In an embodiment, the look-up table is represented in the bitstream and/or in encoding/decoding operation using a set of “pivot points” representing a piece-wise linear function. Each pivot point represents a conversion of an input HDR Y value to an output LDR Y value. A linear function between each two adjacent pivot points is used to map the other HDR Y values (not represented by the pivot points themselves) to LDR Y values. A decoder or any other entity may decode the set of pivot points so that a complete lookup table is formed, representing a mapping from each HDR Y value.

The term tone mapping, as such, may alternatively or additionally be used to indicate a mapping from one color representation model or color gamut to another. Several such tone mapping methods and related signaling means have been proposed. For example, the color remapping SEI message of HEVC may be used for such a purpose. The SEI message comprises indication of the color primaries, transfer function and matrix coefficients corresponding to the signal that is obtained by applying the specified color remapping. The SEI message comprises parameters for a color remapping model comprising a first piece-wise linear function applied to each color component, a three by-three matrix applied to the three color components, and a second piece-wise linear function applied to each color component. The SEI message may be used for example to map a wide color gamut signal (e.g. according to ITU-R BT.2020) to a narrower color representation (e.g. ITU-R BT.709).

According to an embodiment, said look-up table may handle more than one color component, such as the Y, U and V components or the R, G, and B components as input and/or as output. The Y, U and V components may all be represented e.g. as 12-bit HDR values. The look-up table may be used for color gamut conversion in addition to converting from HDR to LDR. For example, the look-up table may convert a signal from ITU-R BT.2020 color gamut, represented by a bit stream, to a signal of ITU-R BT.709 color gamut. In an embodiment, the look-up table is arranged as a three-dimensional look-up table or an octree. The octree may be partitioned unevenly along different color component axes, e.g. into 8×2×2 cuboids or octants (e.g. along axes YxUxV). For each cuboid or octant, a linear model for converting the input sample values to the output sample values may be provided or derived. The 3D LUT and the linear models for cuboids may be encoded and decoded e.g. similarly to the 3D LUT used for color gamut scaling in SHVC.

According to an embodiment, specification of a tone mapping operator includes, in addition to or instead of one or more embodiments above, the presence of parametric values in the bitstream that are applied to a mathematical function to derive a tone mapping function, or parametric values that determine local adaptation of a tone mapping operator. Said parametric values may include a bias threshold, one or more filter taps, and/or a variance threshold.

According to an embodiment, specification of a tone mapping operation is a combination of any two or more of a mathematical formula, a lookup table and a parametric definition, which may be combined for example by applying them sequentially. In an embodiment, specification of a tone mapping operation comprises a first piece-wise linear function, a three by-three matrix applied to the three color components, and a second piece-wise linear function.

In HEVC, there has been defined a mastering display colour volume SEI message, which enables indication of the color volume of a display that was used for viewing while authoring the video content, which may be considered to characterize an optimal display for the content. The SEI message comprises the following information:
The color primaries of the display specify the normalized x and y chromaticity coordinates of each color component.
The white point specifies the normalized x and y chromaticity coordinates, respectively, of the white point of the mastering display.
The nominal maximum and minimum display luminance, respectively, of the mastering display in units of 0.0001 candelas per square meter. At minimum luminance, the mastering display is considered to have the same nominal chromaticity as the white point.

According to an embodiment, which may be applied together with or independently of other embodiments, a tone mapping operation is associated with a specification of target display characteristics, which specify the ideal display on which the tone-mapped signal should be represented. The specification of the target display characteristics may, for example, comprise all or a subset of the information included in the mastering display colour volume SEI message of HEVC. For example, the specification of the tone mapping operator and the specification of the target display characteristics may be included, by an encoder or another entity, into the same SEI message, and decoded, by a decoder or another entity, from the same SEI message. In an embodiment, a decoder or another entity selects or determines a tone mapping operator such that the display on which the tone-mapped content is displayed has characteristics equal or close to the display characteristics indicated for the tone mapping operator.

According to an embodiment, more than one pair of a tone mapping operation and the associated target display characteristics are specified. A decoder or another entity selects two or more pairs in a manner that the display on which the tone-mapped content is displayed has characteristics close to the display characteristics indicated for the selected tone mapping operator. The selected tone mapping operators are combined. Weights applied for the combination may be determined based on the characteristics of the display in use and the characteristics of the targeted displays associated with the selected tone mapping operators. For example, if the characteristics of the target displays are otherwise identical but differ in maximum luminance being equal to y1 and y2, where y1<y2. The maximum luminance of the display in use is y3, where y1<y3<y2. Let the output of a first and second selected tone mapping operator for a certain pixel be equal to a1 and a2, respectively. Then, weighting may be applied so that the final tone-mapped output is equal to (y3−y1)/(y2−y1)*a1+(y2−y3)/(y2−y1)*a2. It is noted that other than linear weighting may alternatively be applied. It is noted that in addition to or instead of multiplicative weighting, an offset term may be derived and summed up to an intermediate value used in deriving the final tone-mapped value. It is noted that while the formula here is presented for one color component, such as luma, the formula may additionally or alternatively be similarly applied to other color components. It is noted that while weighting is applied to the outputs of the selected tone mapping operations in the example, weighting may additionally or alternatively be applied to the tone mapping operations itself, e.g. to the multiplicative weighting factors of the tone mapping operations.

According to an embodiment, a decoder or another entity selects two tone mapping operations from two or more indicated or pre-defined tone mapping operations. For example, when target display characteristics are associated with tone mapping operations, the decoder or another entity may select two tone mapping operations that are associated with display characteristics close to those of the display in use. In another example, one selected tone mapping operator may represent a “dark” tone mapping, and another selected tone mapping operator may represent a “bright” tone mapping. In an embodiment, an end-user may be provided means to weight between the selected two tone mapping operations. For example, the user may have a control that is indicative of a weight w between 0 and 1, inclusive, where the value of 0 specifies that only a first tone mapping operation is applied and the value of 1 specifies that only a second tone mapping operation is applied. Let the output of a first and second selected tone mapping operator for a certain pixel be equal to a1 and a2, respectively. The final tone-mapped output is equal to (1−w)*a1+w*a2.

According to an embodiment, a decoder or another entity selects more than two tone mapping operations (e.g. three) from three or more indicated or pre-defined tone mapping operations. For example, when target display characteristics are associated with tone mapping operations, the decoder or another entity may select two tone mapping operations that are associated with display characteristics close to those of the display in use. In an embodiment, an end-user may be provided means to weight between the selected more than two tone mapping operations. Each of the selected more than two tone mapping operations may be applied to samples of an HDR picture and the resulting collocated tone-mapped samples may be weighted and summed up to produce a sample in an LDR picture.

A tone mapping operator may be specified in the header of the video bit stream, for example in the sequence parameter set or picture parameter set. A tone mapping operator may alternatively or additionally be specified in a supplemental enhancement information (SEI) message. A tone mapping operator may alternatively or additionally be specified in a manner intended for storage or transmission along with the video bit stream, such as in a file format or payload data, such as an ISOBMFF ‘box’ or XML element.

According to an embodiment, the bit stream is a network abstraction layer (NAL) unit based HEVC (H.265) video bitstream, wherein tone mapping information is carried in a supplemental enhancement information (SEI) message.

According to an embodiment, the SEI message specifies tone mapping information that applies a pre-defined part of the bitstream, such as to the entire video bit stream, a CVSG, or a CVS. In other embodiments, the SEI message tone mapping information applies until a pre-defined trigger occurs, such a trigger including the activation of a new sequence parameter set (SPS) or a particular NAL unit type. In still other embodiments, the SEI message includes an indicator of the duration for which the tone mapping information remains valid, for example in units of time or number of frames or by specifying a concluding picture order count (POC) value. According to an embodiment, the tone mapping information in an SEI message remains in effect until a subsequent tone mapping SEI message is received. Therefore, if a tone mapping SEI message is sent for each frame in the video bit stream, the tone mapping information in one SEI message applies to precisely one frame. In another embodiment, the tone mapping information in an SEI message applies to one NAL unit or to one video frame. In yet another embodiment, the tone mapping SEI message persistence is specified as a combination of two or more previously mentioned mechanisms. For example, the SEI message may be specified to pertain until the end of the CVS or until another SEI message of the same type, whichever is earlier in decoding or bitstream order.

According to an embodiment, which may be applied together with or independently of other embodiments, specification of an HDR metadata element includes one or more of the following:
the maximum brightness, in ‘nits’ (i.e. candelas per square meter) or any other explicit or relative unit of measure, of the original video scene;
the minimum brightness, in ‘nits’ or any other explicit or relative unit of measure, of the original video scene;
a set or brightness ranges, in ‘nits’ or any other explicit or relative unit of measure, represented by the original video scene.

Alternatively or equivalently, one or more of the above-mentioned properties may represent the maximum brightness, the minimum brightness and a set of brightness ranges that should be reproduced at the display of the HDR video. In addition to or instead of brightness properties, HDR metadata element may comprise similar color gamut properties, such as a maximum, a minimum, and/or a set of ranges represented along certain color component axis. Additionally or alternatively, HDR metadata may comprise the chromaticity coordinates of the white point of the video scene and/or the intended display. Additionally or alternatively, HDR metadata may comprise the color primaries of the video and/or the intended display.

According to an embodiment, a tone mapping operation is adapted based on the indicated maximum brightness of the scene. This can be performed e.g. by adjusting the parameters of a specific tone mapper or performing a secondary operation on the output of a primary tone mapping process to expand or compress the output range of the primary tone mapper to a desired range. The desired output range may be defined to correspond the brightness range of the original content and it may be further refined either automatically considering the display characteristics and viewing environment or it can be refined based on input of the user operating the display device; or a combination of those.

According to an embodiment, specification of a tone mapping operator includes, in addition to or instead of one or more embodiments above, defining one or more regions and the tone mapping operator that should apply to each, said tone mapping operators being either pre-defined or being described in the bit stream by an index, look-up table or parametrically, and said regions being defined by at least one of
spatial location, size, and shape of the region, which may be represented e.g. by height, width, vertices, center position, top-left position, and/or radius;
intensity or colour range, which may be represented e.g. by a luminance (Y) range or an octree partitioning and an index of the octant within the octree;
intensity variance.

A tone mapping operator may be specified once for an entire video sequence, once for each frame of video, for a given number of frames of video, or may be specified to apply until such time as a different tone mapping operator is specified. When applied to multi-layer video stream, a tone mapping operator may be specified layer-wise, the layers to which the tone-mapping operator applies may be specified and indicated in the bitstream e.g. using a scalable nesting SEI message to contain a tone mapping SEI message, or a tone mapping operator may be specified to apply to all primary video layers of the multi-layer video stream.

According to an embodiment, specification of a tone mapping operator includes, in addition to or instead of one or more embodiments above, a map indicating which tone mapping operator is to be applied to each particular pixel in a frame or a subset of a frame of video. The map may take the form of an auxiliary picture.

According to an embodiment, one or more of the following signaling may be used for an auxiliary picture or alike that specifies a mapping which tone mapping operator is to be applied for pixels of a certain picture of “primary” video or a subset, such as a rectangular region, of a certain picture of “primary picture”:
Storage of an auxiliary picture (potentially along with other auxiliary pictures) logically in a different bitstream from the bitstream containing the primary picture, and using systems means to associate the auxiliary picture and the primary picture with each other. The systems means may include but are not limited to one or more of the following:
   A container file format, such as the ISO Base Media File Format (ISOBMFF) or its derivatives, may be used to indicate the association of the auxiliary picture/video and the primary picture/video. For example, in ISOBMFF auxiliary pictures may be stored as an auxiliary video track and linked through a track reference to the primary video track. An auxiliary picture in an auxiliary video track may be associated with a primary picture in a primary video track through the same decode time in both. In the Image File Format, an auxiliary picture may be stored as an item and linked through an item reference to a primary picture (also stored as an item).
   A streaming manifest, such as the MPD of MPEG-DASH, RTSP, or SDP, may indicate the relation of two streams or representations, one comprising the auxiliary picture and the other comprising the primary picture.
Storage of an auxiliary picture in the same bitstream as the primary picture, using e.g.:
   A specific NAL unit type, indicating an auxiliary picture, similarly to how auxiliary pictures are enabled in H.264/AVC.
   An auxiliary picture layer, similarly to how auxiliary picture are enabled in HEVC.
   Any of the methods above for associating auxiliary video and primary video in different logical channels (e.g. tracks, streams, or representations) with each other may be applied also in the case that from the coding format or the decoding process perspective both primary and auxiliary video are logically parts of the same bitstream.

According to an embodiment, the auxiliary picture or similar is effectively a binary mask indicating which of one of two associated TMOs is applied for each pixel. For example, a binary mask may be specified similarly to an alpha plane that specifies only fully opaque and fully transparent pixels. It is noted that one tone mapping operator may be a scalar multiplication or other simple arithmetic operation, so that the auxiliary picture effectively determines whether or not to apply a tone mapping operator. For example, there may be a ‘linear range’ common to both low dynamic range and high dynamic range representations. In other embodiments, the scalar multiplication or other simple arithmetic operation is applied to every pixel as a pre-processing step, so that the auxiliary picture or similar indicates whether each pixel is subject to a tone mapping operation or whether it is unmodified after the step of pre-processing.

Blending is the process of combining two images into a single image. One of the images (the image to be blended, denoted as F here) is associated with an auxiliary image identified as an alpha plane. The alpha channel information SEI message of HEVC or similar may be used to specify how the pixel values of image F are converted to an image B consisting of interpretation values. Let the image A be the image over which the image B is blended. The respective spatial positions of images A and B (relative to each other) may be indicated or the images may be assumed to be collocated. The following formula or similar may be used for the blending operation, where bgPixel in image A, fgPixel in image B, and alphaPixel in the alpha plane image are collocated.

alphaRange=Abs(alpha_opaque_value−alpha_transparent_value)

alphaFwt=Abs(alphaPixel−alpha_transparent_value)

alphaBwt=Abs(alphaPixel−alpha_opaque_value)

outputPixel=(alphaFwt*fgPixel+alphaBwt*bgPixel+alphaRange/2)/alphaRange

According to an embodiment, the auxiliary picture or similar is indicative of a linear weighting between two associated TMOs applied for each pixel. For example, an auxiliary picture may be treated similarly to an alpha plane specifying a first sample value level for full transparency, a second sample value level for full opaqueness, and sample values in between these two levels indicate partial transparency or opaqueness in a linear fashion. For example, referring back to the above formulas, the following processing or alike may be used:
Let fgPixel be the value resulting from applying a first TMO to a first pixel in the primary picture
Let bgPixel be the value resulting from applying a second TMO to the first pixel
The outputPixel is derived using the formulas provided for alpha blending and may be understood as a linearly weighted combination between applying the two associated TMOs for each pixel according to the auxiliary picture.

According to an embodiment, the auxiliary picture or similar is indicative of a non-linear weighting between two associated TMOs applied for each pixel. The non-linear weighting function may be pre-defined for example in a coding standard. Alternatively or in addition, the non-linear weighting function may be determined and indicated in or along the bitstream by an encoder and/or decoded from or along the bitstream by a decoder. In case the use of more than one pre-determined and/or indicated non-linear weighting functions is allowed and enabled, the encoder may indicate in or along the bitstream which weighting function is in use for a particular picture and the decoder may decode from or along the bitstream which weighting function is in use for a particular picture. A non-linear weighting function may be specified for example as a piece-wise linear function where discontinuities are allowed. A linear weighting function may be understood as a special case of a non-linear weighting function. A sample value or values of an auxiliary picture may be used as input to the non-linear weighting function, whereas the result of the weighting function may be used in weighting the sample values resulting from applying the two TMOs.

According to an embodiment, more than two TMOs may be associated with an auxiliary picture and the sample values of the auxiliary picture may be used to determine which one of the more than two TMOs is applied for each pixel.

According to an embodiment, more than two TMOs may be associated with an auxiliary picture and the sample values of the auxiliary picture may be used to determine the weights for the TMOs applied to obtain a tone-mapped picture. For example, a sample value range may be partitioned into sub-ranges, where the endpoints of each sub-range correspond to a particular TMO. The values within a sub-range correspond to a weighted combination of the TMOs of the endpoints of the sub-range. In different embodiments, linear weighting or non-linear weighting, similarly to what is explained above, may be used.

According to another embodiment, the auxiliary picture may contain elements of N bits, and the number of TMOs is less than or equal to N. Each bit position of a pixel value in the auxiliary picture is assigned to a particular TMO, and a bit equal to 1 specifies that this TMO is applied for the pixel, whereas a bit equal to 0 specifies that the associated TMO is not applied for the pixel. The resulting output pixel value is a combination of the results of applied tone mappers, where the combination may be a linear combination, for example an average value.

According to an embodiment, which may be applied together with or independently of other embodiments, an auxiliary picture may be indicated (e.g. by an encoder) to correspond to a subset of a primary picture. For example, the scaled reference layer offsets of HEVC or similar may be used for indicating the spatial correspondence.

According to an embodiment, which may be applied together with or independently of other embodiments, an auxiliary picture may be downsampled or subsampled or may inherently have a smaller spatial resolution, so that each pixel in the auxiliary picture corresponds to more than one pixel in a frame of video. In order to obtain a sample value that is to be used for tone mapping of a particular pixel in a primary picture, for example one of the following may be applied:
The decoded auxiliary picture may be upsampled so that the pixels in the upsampled auxiliary picture have a one-to-one mapping to the pixels in the primary picture. The upsampling algorithm and/or filter may be pre-defined e.g. in a coding standard. Alternatively, a set of upsampling algorithms and/or filters may be pre-defined, the encoder may indicate in the bitstream which upsampling algorithm or filter is to be used, and the decoder may decode from the bitstream which upsampling algorithm or filter is to be used and use it for the upsampling of the auxiliary picture. Alternatively, the encoder may indicate the upsampling algorithm or filter in the bitstream, e.g. by listing the number of filter taps and their values, and the decoder may decode the upsampling algorithm or filter from the bitstream.
The coordinates of a pixel in the primary picture may be mapped to coordinates of a respective pixel in the auxiliary picture. More than one pixel of the primary picture may be mapped the same coordinates in the auxiliary picture.

According to an embodiment, more than one auxiliary picture may be associated with a primary picture. For example, the associated auxiliary pictures may correspond to different spatial regions of the primary picture, e.g. indicated as discussed above.

It is noted that the auxiliary pictures described heretofore may be associated with one or more color components of the video representation individually, or may be common to all color components. That is, there may be three auxiliary pictures, each corresponding to one of the Y, U and V components, in which case the terms ‘pixel’ and ‘pixel value’ refer to the point value of the Y, U or V component as applicable.

Any embodiment heretofore that is described in relation auxiliary pictures may utilize auxiliary picture layers of HEVC or auxiliary picture layers similar to those of HEVC. Likewise any of these embodiments may be utilize a layer associated with another type of scalability dimension rather than auxiliary identifier; for example, a dedicated scalability dimension may be associated for a layer providing data for HDR to LDR mapping according to any embodiment.

According to an embodiment, an inter-layer process is used in an encoder and/or a decoder to form a prediction signal for an LDR layer from an HDR layer and, in some embodiments, a layer providing data for HDR to LDR mapping. Such an inter-layer process may be performed according to any embodiment specifying how tone mapping is performed. An encoder may indicate in the bitstream (e.g. into a sequence-level syntax structure, such as SPS) and/or a decoder may parse from the bitstream information indicative whether prediction error data may be present for the LDR layer or is not present for the LDR layer. Additionally or alternatively, an encoder may indicate in the bitstream (e.g. into a sequence-level syntax structure, such as SPS) and/or a decoder may parse from the bitstream information indicative whether the prediction error data is mandatory to be decoded or can be decoded, where the latter case may be interpreted in a way that the tone mapping operation of the inter-layer processing produces sufficient quality to be displayed and the enhancement data provided by the coded prediction error is an optional enhancement.

According to another embodiment, a syntax element in the bitstream indicates whether a specified tone mapping operator applies to all color components, or whether multiple tone mapping operators are specified, each tone mapping operator specified as provided for in this invention and applying to one or more color component of the video representation. That is, the tone mapping operation as specified in this invention may be repeated multiple times, with a syntax element such as a ‘tone mapping map’ indicating which specified tone mapping operation is applied to which color component of the video signal.

It is possible that an HDR video representation is first tone mapped (through application of a tone mapping operator) to a ‘pseudo-HDR’ video representation. This may alternatively be referred to as ‘medium dynamic range’. The further conversion of this video representation to an LDR video representation can be achieved by application of additional tone mapping operators. In other words, conversion from high- to medium- to low dynamic range may be achieved by ‘chaining’ multiple tone mapping operators. However, conventional tone mapping operators assume the video representation to have certain characteristics. Therefore, tone mapping of a video representation that has already been tone mapped may require either an ‘inverse tone mapping’ prior to application of a conventional tone mapping operator, or it may require the conventional tone mapping operator to be modified to take into consideration the new characteristics of the medium dynamic range video representation.

According to an embodiment, which may be applied together with or independently of other embodiments, specification of an HDR metadata element includes the tone mapping operator that has already been ‘pre-applied’ to the video signal prior to encoding it into the video bit stream, said tone mapping operators being either pre-defined or being described in the bit stream by an index, look-up table, parametrically, or in a map. Any of the previously presented embodiments or a combination thereof may be used for describing the tone mapping applied to the video prior to its encoding.

According to an embodiment, specification of an HDR metadata element further includes an indicator of whether pre-processing of the video bit stream is required prior to application of an LDR tone mapping operator, or whether the specified LDR tone mapping operators can be applied directly to the video representation in the bit stream.

In the event that pre-processing of the video bit stream is required prior to application of an LDR tone mapping operator, the step of pre-processing includes application of an inverse tone mapping operation, or ‘tone recovery operation’, to the video representation in the bit stream, the inverse tone mapping operation being pre-defined or being described in the bit stream by an index, look-up table, parametrically, or in a map, or being derived from the indicated tone mapping operator that was pre-applied to the video signal prior to encoding it.

FIG. 8 shows a block diagram of a video decoder suitable for employing embodiments of the invention. FIG. 8 depicts a structure of a two-layer decoder, but it would be appreciated that the decoding operations may similarly be employed in a single-layer decoder.

The video decoder 550 comprises a first decoder section 552 for base view components and a second decoder section 554 for non-base view components. Block 556 illustrates a demultiplexer for delivering information regarding base view components to the first decoder section 552 and for delivering information regarding non-base view components to the second decoder section 554. Reference P′n stands for a predicted representation of an image block. Reference D′n stands for a reconstructed prediction error signal. Blocks 704, 804 illustrate preliminary reconstructed images (I′n). Reference R′n stands for a final reconstructed image. Blocks 703, 803 illustrate inverse transform (T⁻¹). Blocks 702, 802 illustrate inverse quantization (Q⁻¹). Blocks 701, 801 illustrate entropy decoding (E⁻¹). Blocks 705, 805 illustrate a reference frame memory (RFM). Blocks 706, 806 illustrate prediction (P) (either inter prediction or intra prediction). Blocks 707, 807 illustrate filtering (F). Blocks 708, 808 may be used to combine decoded prediction error information with predicted base view/non-base view components to obtain the preliminary reconstructed images (I′n). Preliminary reconstructed and filtered base view images may be output 709 from the first decoder section 552 and preliminary reconstructed and filtered base view images may be output 809 from the first decoder section 554.

Herein, the decoder should be interpreted to cover any operational unit capable to carry out the decoding operations, such as a player, a receiver, a gateway, a demultiplexer and/or a decoder.

In the above, some embodiments have been described in relation to encoding information, e.g. related to tone mapping operations, into the bitstream and/or decoding information from the bitstream. It needs to be understood that embodiments could be similarly realized when such information is additionally or alternatively encoded into and/or decoded or parsed from a container file (e.g. complying with ISOBMFF) encapsulating or referring to the bitstream. Likewise, it needs to be understood that embodiments could be similarly realized when such information is additionally or alternatively encoded into and/or decoded or parsed from a streaming manifest, such as the MPD of MPEG-DASH, RTSP, or SDP, that also describes and/or provides access to (e.g. through uniform resource locators) the bitstream. Likewise, it needs to be understood that embodiments could be similarly realized when such information is additionally or alternatively encoded into and/or decoded or parsed from metadata of a transport format or protocol, such as MPEG-2 transport stream, in which metadata may be included e.g. in so-called descriptors.

In the above, some embodiments have been described in relation to ISOBMFF. It needs to be understood that embodiments could be similarly realized with any other file format, such as Matroska, with similar capability and/or structures as those in ISOBMFF.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe embodiments of the invention operating within a codec within an electronic device, it would be appreciated that the invention as defined in the claims may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A method comprising:
obtaining a video bitstream comprising a high dynamic range (HDR) video representation;
obtaining one or more tone mapping operators and an indication of at least one tone mapping operator to be applied; and
modifying the HDR video representation into a low dynamic range (LDR) video representation using said at least one tone mapping operator determined by said indication.

2. The method according to claim 1, wherein said indication comprises a specification of a tone mapping operator through a presence of one or more syntax elements, the syntax elements or their value(s) indicating which one of said tone mapping operators is used in the step of modifying the HDR video representation.

3. The method according to claim 1, wherein said indication comprises a specification of a tone mapping operator including presence of a look-up table to be used for substituting lower dynamic range and/or lower bit depth values for higher dynamic range and/or higher bit depth values present in the video bitstream.

4. The method according to claim 3, wherein said look-up table comprises only a luminance component for the HDR representation and the LDR representation.

5. The method according to claim 3, wherein said look-up table comprises more than one color component for the HDR representation and the LDR representation.

6. The method according to claim 1, wherein said indication comprises a specification of a tone mapping operator including presence of parametric values that are used to derive a tone mapping function, or parametric values that determine local adaptation of a tone mapping operator.

7. The method according to claim 1, wherein at least one tone mapping operator is associated with a specification of target display characteristics.

8. The method according to claim 1, wherein said indication comprises at least two tone mapping operators, and the step of modifying the HDR video representation comprises sequential application of said at least two tone mapping operators.

9. The method according to claim 1, where the step of modifying the HDR video representation into a low dynamic range (LDR) video representation using said at least one tone mapping operator determined by said indication additionally comprises a pre-processing operation.

10. An apparatus comprising
at least one processor and at least one memory, said at least one memory stored with code thereon, which when executed by said at least one processor, causes the apparatus to perform at least
obtaining a video bitstream comprising a high dynamic range (HDR) video representation;
obtaining one or more tone mapping operators and an indication of at least one tone mapping operator to be applied; and
modifying the HDR video representation into a low dynamic range (LDR) video representation using said at least one tone mapping operator determined by said indication.

11. A computer readable storage medium stored with code thereon for use by an apparatus, which when executed by a processor, causes the apparatus to perform:
obtaining a video bitstream comprising a high dynamic range (HDR) video representation;
obtaining one or more tone mapping operators and an indication of at least one tone mapping operator to be applied; and
modifying the HDR video representation into a low dynamic range (LDR) video representation using said at least one tone mapping operator determined by said indication.

12. A method comprising:
providing a high dynamic range (HDR) video representation or information relating to the HDR video representation; and
providing a bitstream comprising one or more tone mapping operators and an indication of at least one tone mapping operator to be applied to said HDR video representation.

13. The method according to claim 12, wherein said indication comprises a specification of a tone mapping operator including presence of one or more syntax elements, the syntax elements or their value(s) indicating which one of said tone mapping operators is used in the step of modifying the HDR video representation.

14. The method according to claim 12, wherein said indication comprises a specification of a tone mapping operator including presence of a look-up table to be used for substituting lower dynamic range and/or lower bit depth values for higher dynamic range and/or higher bit depth values present in the video bitstream.

15. The method according to claim 14, wherein said look-up table comprises only a luminance component for the HDR representation and the LDR representation.

16. The method according to claim 14, wherein said look-up table comprises more than one color component for the HDR representation and the LDR representation.

17. The method according to claim 12, wherein said indication comprises a specification of a tone mapping operator including presence of parametric values that are used to derive a tone mapping function, or parametric values that determine local adaptation of a tone mapping operator.

18. The method according to claim 12, wherein at least one tone mapping operator is associated with a specification of target display characteristics.

19. An apparatus comprising
at least one processor and at least one memory, said at least one memory stored with code thereon, which when executed by said at least one processor, causes the apparatus to perform at least
providing a high dynamic range (HDR) video representation or information relating to the HDR video representation; and
providing a bitstream comprising one or more tone mapping operators and an indication of at least one tone mapping operator to be applied to said HDR video representation.

20. A computer readable storage medium stored with code thereon for use by an apparatus, which when executed by a processor, causes the apparatus to perform:
providing a high dynamic range (HDR) video representation or information relating to the HDR video representation; and
providing a bitstream comprising one or more tone mapping operators and an indication of at least one tone mapping operator to be applied to said HDR video representation.
